(19) United States
(12) Patent Application Publication
(10) Pub. No.: US 2003/0001473 A1
(43) Pub. Date: Jan. 2, 2003

(54) Laterally spaced multiple electron gun color cathode ray tube device

(75) Inventors: Albertus A.S. Sluyterman, Eindhoven (NL); Evert Seevinck, Eersel (NL)

Correspondence Address: Corporate Patent Counsel, U.S. Philips Corporation, 580 White Plains Road, Tarrytown, NY, 10591, US

(73) Assignee: U.S. Philips Corporation

(21) Appl. No.: 10/211,030

(22) Filed: Aug. 2, 2002

Related U.S. Application Data
(63) Continuation of application No. 09/218,548, filed on Dec. 22, 1998.

(30) Foreign Application Priority Data
Dec. 23, 1997 (EP) 97204084.4
Jun. 30, 1998 (EP) 98202194.1

(51) Int. Cl. H01J 31/00

(52) U.S. Cl. 313/2.1

(57) ABSTRACT

A cathode ray tube device in which two deflection yokes and two electron guns are used, but in which only one shadow mask is used. Image uniformity is obtained by creating a partial overlap of the two images created by the two yokes.

The present invention relates to a colour cathode ray tube device in which the screen section is divided in a plurality of sub-regions and means for separately scanning the sub-regions.

In recent years there has been considerable research aimed at meeting demands relating to high definition colour cathode ray tube or associated large-screen high resolution colour cathode ray tubes. One requirement for achieving in such tubes is that the electron beam spot on the screen is made smaller. There have also been efforts in the past to improve the electron gun electrode structure and to lengthen and increase the size and aperture of actual electron guns, but results achieved so far have been unsatisfactorily. The main reason for this is that the electron gun-to-screen distance becomes larger as a cathode ray tube becomes larger. Thus, the electron gun magnification becomes too large. According, reducing the electron gun-to-screen distance is an important aspect of achieving high resolution. Methods for wide-angle deflection are not practical for this purpose, since they result in an increased difference in magnification between central and peripheral portions of the screen.

In response to this drawback, a structure in which the screens of a plurality of horizontally disposed, independent CRT's are combined into a unitary screen has been proposed in Japanese Utility Model Publication No. 39-25641, Japanese Patent Publication No. 42-4928 and Japanese Patent Disclosure No. 50-17167.

These known structures have, however, the problem that joints are visible between the independent colour cathode ray tubes.

It is an object of the invention to provide a cathode ray tube in which the above mentioned problem is reduced or overcome.

To this end a cathode ray tube device in accordance with the invention is characterized in that device comprises a single colour cathode ray tube which has, arranged in a linear arrangement, a multitude of necks, deflection yokes and electron guns, but only one shadowmask.

When colour displays are provided by tubes such as this, in which the screen section is a unitary section and divided scanning is effected, a colour cathode ray tube employing a single shadow mask system for colour selection permits simple, but sure, colour selection and is very practical.

A colour cathode ray tube employing a multi-neck system such as this with a unitary screen structure makes it possible to produce an image that is easy to view, since it eliminates the joints between adjacent cathode ray tubes which occur with an array of independent cathode ray tubes, as described above. The necks are all aligned in a linear arrangement, i.e. substantially along a single line. Preferably an improved image uniformity is obtained by creating a partial overlap of two images created in two adjacent sub-regions. The preferred number of sub-regions is two or three. When two sub-regions are scanned (and thus only two inkiest, deflection units etc are used) the device is relatively simple. As the number of sub-regions increase the device gets more complicated. The use of three sub-regions has the advantage that the overlap regions are not in the middle of the image, whereby the change of annoying visibility of the overlap regions is reduced, while the device as a whole is relatively simple, be it more complicated then for two sub-regions.

The purpose of the invention is to create a CRT with a reduced depth. Other concepts for reduced-depth CRT displays, like the Matsushita “Flat Vision”, deviate so much from a conventional CRT that they cannot be manufactured in a normal CRT factory. An approach, in which a two dimensional array of many yokes are used, also deviates significantly from a normal CRT. The cathode ray tube in accordance with the invention requires much less deviation from normal techniques.

These and further aspects of the invention will be illustrated in the drawings in which

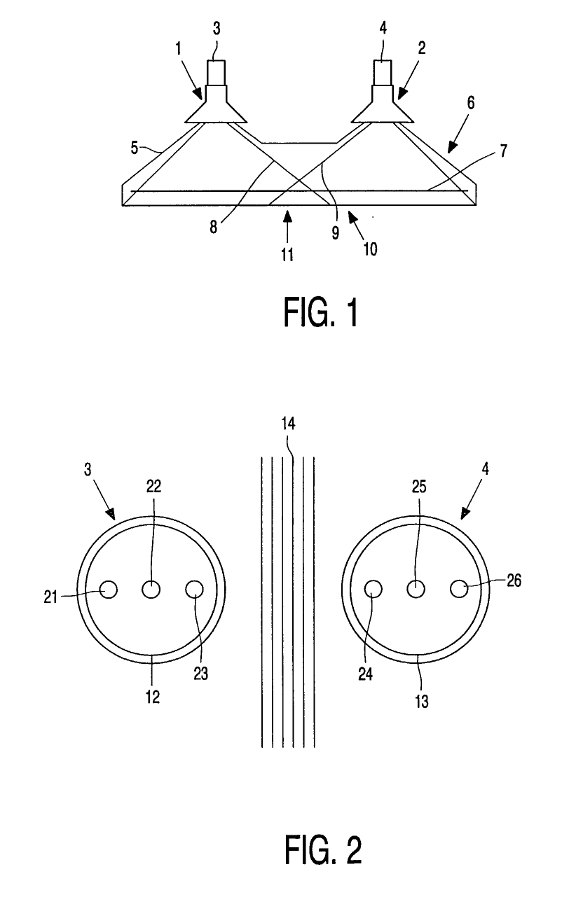

FIG. 1 shows a colour display device in accordance with the invention;

FIG. 2 shows schematically a possible arrangement of the electron beams and the phosphor lines;

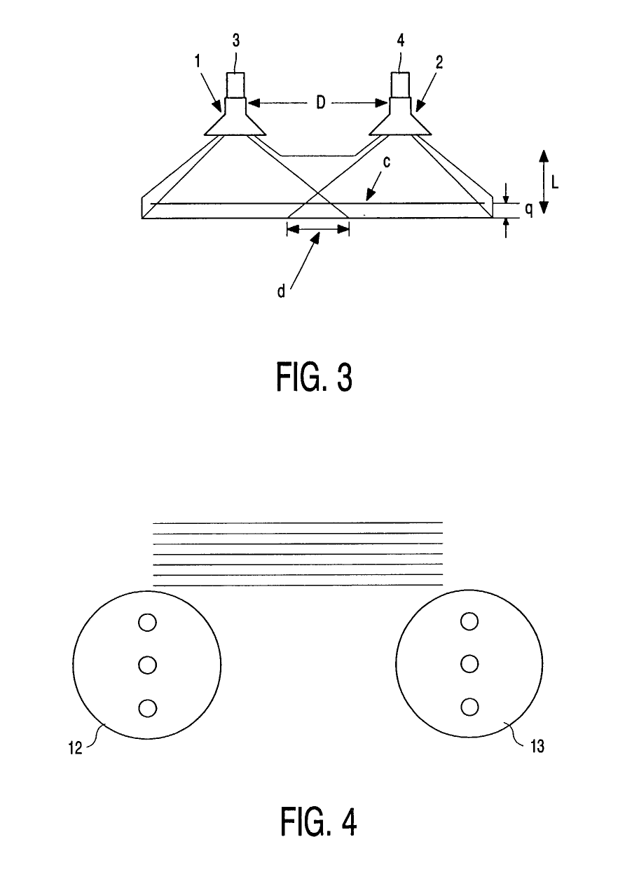

FIG. 3 shows relation between the width of the overlap area and other parameters

FIG. 4 shows schematically a further possible arrangement of the electron beams and the phosphor lines.

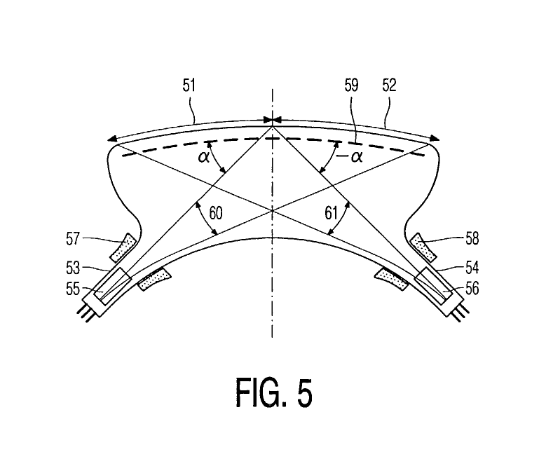

FIG. 5 shows schematically a further embodiment of a colour display device in accordance with the invention.

The drawings are schematic and in general not to scale.

FIG. 1 shows a top view on the “Camel” CRT. Visible are two deflection yokes 1 and 2 positioned around necks 3 and 4, two partial cones 5 and 6, which are part of one envelope within which one shadow mask 7 is present and the scanning area's of the beams 8 and 9 on luminescent screen 10 of the tube. The figure also shows that there is an overlap area 11 for the images created by the two yokes.

For the camel CRT there are two options for the orientation of the guns and the shadow mask. In one option the guns are in-line guns with their orientation in the horizontal direction as shown in FIG. 2 in which a front view on a Camel CRT with a horizontal orientation of the guns leading to vertical phosphor lines as in conventional CRT's is shown. In neck 3 an electron gun 12 is provided for generating three electron beams 21, 22 and 23. In neck 4 an electron gun 13 is provided for generating three electron beams 24, 25 and 26. FIG. 3 shows a criterium for the distance between the necks of the tube, in relation to the mask to screen distance and the screen pitch at the centre of the screen.

In an other option, the guns, phosphor lines and shadow mask are rotated over 90°, as shown in FIG. 4. In this embodiment the apertures of the gun are arranged in a vertical orientation while horizontally oriented phosphor lines are used.

In one embodiment the guns, the phosphor lines and mask have an orientation like normally used in TV tubes and was shown in FIG. 2. Then it is necessary that the distance between the necks of the guns is chosen according to the following rule: When the centre beams of the two sets of yokes go through one and the same hole in the shadow mask, both beams must reach a green phosphor line. This means that the distance d between the landing points of these two beams on the screen must be an integer times the screen pitch. This distance d is determined by the distance D between the tube necks and the distance q (at the screen centre) between the mask and the screen. From FIG. 3 it follows that D/d=(L-q)/q where L is the distance to the deflection point of the deflection unit and the screen.

In a second embodiment the electron beams of each of the two guns are positioned above each other as shown in FIG. 4. In this embodiment the phosphor lines are oriented horizontally (also shown in FIG. 4) and the line shaped mask holes are oriented in the horizontal direction. In this embodiment overlap of the two images is possible without colour purity problems. So in this embodiment there is no requirement for specific distances between the two necks of the gun. In this embodiment there are two ways of scanning. One way is to scan horizontally, as normally done in a TV set. However that can contribute to scan moire. Therefore it is preferred to scan vertically (linescan vertical, field scan horizontally). In this arrangement it is advantageous if the field deflection coils are driven in an anti-phase mode, which means that, in operation, they are scanning in opposing directions. The result is that both of the sub-images are writing in the overlap area simultaneously. One advantage is that the DC offset of the frame deflection coils can be used for controlling the overlap of the sub-images. It is also advantageous to use the trapezium correction normally used for East/West trapezium distortions) to eliminate the trapezium distortions arising from the curvature of the screen.

An advantage of using frame coils in anti-phase, or line deflection coils in anti-phase when normal, not rotated, scanning directions are used, is that stray fields generated by the frame, respectively line deflection coils are in anti-phase. The stray fields cancel each other to a large degree, which makes it easier to comply with e.g. legal restrictions on stray fields generated by the device. This advantage is not dependent on the use of a shadow mask and could be useful for for instance also a display device having two necks and two electron guns using the index tube principle.

In all embodiments, the overlap of the images can be optimised by making a gradual variation of the intensities of the beams. So the right image has no intensity at the left side of the overlap and a full intensity at the right end of the overlap. For the left image, the image has no intensity at the right end of the overlap and full intensity at the left end of the overlap. The best results are obtained by using within the overlap area the following intensity functions:

I_{left-beams}=(0.5−0.5f(x))*I_{original}

I_{right-beams}=(0.5+0.5f(x))*I_{original}

in which:

| | |
|---|---|
| I_{original} | = beam current needed for the local image when there would |
| | not have been an overlap in that point |
| x | = the horizontal position relative to the centre of overlap |
| d | = the width of the overlap. |
| f (x) | = a function of x, where f (0) = 0 and f (x) = −f (−x) and |
| | f (d/2) = 1 |

Two possible functions are:

f(x)=sin(πx/d)

f(x)=(2x/d)²*sign(x)

The voltage driving the gun can be derived from these function taking the g of the gun (which stands for the non-linearity of the gun) into account.

One criterion for calculating the required accuracy with which the two images created by the two guns must coincide is the luminance variation that results form a stitch error (not exact coincidence). The effect of a stitch error e (i.e. one of the image is displaced by a distance e form the ideal position relative to the other image) can be calculated by shifting the left image by a distance e/2 to the right and the right image by a distance e/2 to the left. The intensity error at the center of the overlap area is given by:

f(e/2). The maximum image intensity error is for the two exemplary functions sin(πx/2d)I_{original} and (x/d)²I_{original} respectively.

For a 5% limit for the luminance variation a stitching error of 1 mm is allowable for a 30 mm overlap. Preferably the overlap are has a width d between 10 and 40 mm. For an overlap shorter than 10 mm stitching errors are difficult to avoid. In the middle of the screen the phosphor pitch will be approximately constant. As the electron beams are scanned to the outerlimits of the scan (i.e. near and at the overlap area) there should, however, be a small phosphor pitch variation. This variation is of opposite sign for the left and right beams. By keeping the overlap to less than or equal to 40 mm problems relating to the above, to some extent contradictory, requirements on the phosphor pitch are kept within reasonable bounds.

Within the concept of the invention many variations are possible. FIG. 5 shows a variation. The colour display device comprises, as the device shown in FIG. 1, two sub-regions 51, 52 and two necks 53, 54 in each neck an electron gun 55, 56 and around each neck a deflection yokes 57, 58. The neck are arranged under an angle with respect to the shadowmask 59, such that the electron beam 60 is scanned over sub-region 52 and electron beam 62 is scanned over sub-region 51. This arrangement has the advantages that the cathode ray tube device is shallower, i.e. the distance between the neck(s) and the front end of the cathode ray tube is reduced. Furthermore the angle of deflection is reduced, which reduces the deflection energy, and the distances between the deflection units is increased, which decreases the possibility of one deflection unit influencing the other deflection unit. In this embodiment the necks are thus arranged at opposite, shallow angles α, -α with respect to the shadow mask.

1. A colour cathode ray tube device in which the screen section is divided in a plurality of sub-regions and means for separately scanning the sub-regions, characterized in that the device comprises a single colour cathode ray tube which has, arranged in a linear arrangement a multitude of necks, deflection yokes and electron guns, but only one shadowmask.

2. A cathode ray tube as claimed in claim 1 or 11, characterized in that the necks are arranged at opposite angles (α, -α) with respect to the shadows mask.

3. A cathode ray tube device as claimed in claim 1, characterized in that the electron guns are in-line electron guns for generating a centre and two outer beams and the screen comprises a phosphor pattern comprising phosphor areas for different colours and in that the distance (D) between the necks, the mask to screen distance (q) and the screen pitch are chosen such that when the centre beams of the two guns go through a same mask hole both beams reach a phosphor area of the same colour.

4. A cathode ray tube device as claimed in claim 3 characterized in that the orientation of the guns, as well as the phosphor line structure as well as the mask structure is rotated over 90° (as shown in FIG. 4).

5. A cathode ray tube device as claimed in claim 4 characterized in that device comprises means for line-scanning in the direction of the shortest screen dimension.

6. A cathode ray tube device as claimed in claim 1, characterized in that the device comprises means for effecting a gradual overlap of two adjacent sub-regions over an overlap area.

7. A cathode ray tube as claimed in claim 6, characterized in that the overlap area has a width d between 10 and 40 mm (10 mm≦d≦40 mm)

8. A cathode ray tube device having a cathode ray tube as claimed in claim 6 and means for driving the cathode ray tube characterized in that the means for driving the cathode ray tubes are for driving the cathode ray tube such that the beam intensities in the overlap area are modulated according to
I_{left-beams}=(0.5−0.5f(x))*I_{original}
I_{right-beams}=(0.5+0.5f(x))*I_{original}
in which:

| | |
|---|---|
| I_{original} | = beam current needed for the local image when there would |
| | not have been an overlap in that point |
| x | = the horizontal position relative to the centre of overlap |
| d | = the width of the overlap |
| f (x) | = a function of x, where f (0) = 0 and f (x) = −f (−x) and |
| | f (d/2) = 1 |

9. A cathode ray tube device as claimed in claim 6 characterized in that the device has means for supplying deflection currents to the deflection units, characterized in that the timing of the deflection currents is such that in the overlap area the beams from both sides are writing the same image at a time difference no more than one or two line periods.

10. A cathode ray tube device as claimed in claim 1, characterized in that the device has means for supplying line and/or field deflection currents to line and/or field deflection coils of the two deflection units, and in that the line and/or field deflection currents are, in operation, supplied with opposite phases.

11. A cathode ray tube device in which the screen section is divided in a plurality of sub-regions and means for separately scanning the sub-regions, characterized in that the device comprises a single cathode ray tube having two necks, two deflection devices and two electron guns, the device has means for supplying line and/or field deflection currents to line and/or field deflection coils of the two deflection units, and the line and/or field deflection currents are, in operation, supplied with opposite phases.
